(19) United States
(12) Patent Application Publication
(10) Pub. No.: US 2006/0184879 A1
(43) Pub. Date: Aug. 17, 2006

(54) Valuable display of identification information

(76) Inventors: Anuthep Benja-Athon, New York, NY (US); Theda Benja-Athun, Port Washington, NY (US)

Correspondence Address: ANUTHEP BENJA-ATHON, 210 E 36TH ST., NEW YORK, NY, 10016, US

(21) Appl. No.: 11/230,278

(22) Filed: Sep. 20, 2005

Related U.S. Application Data
(63) Continuation-in-part of application No. 11/196,823, filed on Aug. 4, 2005.
Application No. 11/196,823 is a continuation-in-part of application No. 11/150,878, filed on Jun. 13, 2005.
Application No. 11/150,878 is a continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G06F 17/00

(52) U.S. Cl. 715/704

(57) ABSTRACT

A system of patients' identification information for labeling, cross-checking and verifying files adaptable to appear on a display screen of a digital voice recorder to effect a physician's dictations of health-care information of patients into appropriate patients' named files.

This application is a continuation-in-part of application Ser. No. 11/196,823 entitled Routing of health information files filed Aug. 4, 2005 which is a continuation-in-part of application Ser. No. 11/150,878 entitled Physicians' optimal management of health information filed Jun. 13, 2005 which is a continuation-in-part of application Ser. No. 11/114,763 entitled A System of Influencing Health-Care Utilizations filed Apr. 27, 2005 which is a continuation-in-part of application Ser. No. 11/074,236 entitled the System of Management of Health-Care Resources filed Mar. 7, 2005 and Ser. No. 11/059,088 entitled the Consumers-Buyers-Physicians Health-Care filed Feb. 16, 2005 which are pending.

### FIELD OF INVENTION

A display of a system of names and identification on a digital voice recorder screen.

### BACKGROUND OF THE INVENTION

This patent application and other patent pendings especially pending application Ser. Nos. 11/196,823, 11/150,878 and 11/114,763 of these patent applicants showed—for the first time in the history of mankind—the significant and vital role and usefulness of digital voice recorders in said inventions which create the best health-care system on earth.

Prior to said inventions, the value of a digital voice recorder (DVR) in health-care was heretofore unknown. In health-care, DVR was heretofore not a smart device. Case in point, DVR-generated files are assigned inconsequential labels that appear as inconsequential numbers or alphanumerics on a display screen of DVR which are neither meaningful nor useful to any and all readers and users of said DVR and inconsequential labels. The results are the lack of progress in the use of DVR to better mankind and grave errors associate with the use of DVR.

However, the present invention solves the above problems and shows how to maximize the function thence value of the display screen of DVR especially in health-care.

### SUMMARY OF THE INVENTION

A system of patients' names, social security numbers, dates of birth and facial images for labeling, cross-checking and verifying individual named files of patients comprising information on said people adaptable to appear on a display screen of a digital voice recorder to optimize the applications of displays on said screen by a physician dictating health-care information of patients into appropriate patients' named files.

### DESCRIPTION OF THE PREFERRED EMBODIMENTS

The present invention is a system or hierarchy of identification information of persons for naming or labeling and verifying files containing information on persons in a digital voice recorder wherein said information are displayed on a display screen of said digital voice recorder to effect and facilitate dictations of persons' information into desired named files. In the health-care setting, said persons are patients.

Said identification information of persons comprise individual distinct names of individual persons such as first and last names of persons. Thus, said system display named files based on people's names. For example, a directory tree comprises and displays 26 alphabetized folders each of which comprises alphabetically sorted named files on the display screen of a DVR. In other words, said directory tree comprises a plurality of folders alphabetically labeled and ordered or sorted in a few arrangements such as, but not limited to, A-Z corresponding to 26 first alphabets of all patients' last names (accomodation is made for certain special last names and variations such as, but not limited to, “Mc” and “O′”). Thus, there are 26 alphabetized or named folders that are sorted from A-Z adaptable to appear on said screen.

Similarly, each alphabetized folder comprises a plurality of named files—with the same first alphabet of the last names—alphabetically ordered or sorted according to the other alphabets after said same first alphabets of all patients' last names. In other words, named files of all patients with the same first alphabet of the last names are contained in a folder of the 26 folders (accomodation is made for certain special last names and variations such as, but not limited to, “Mc” and “O′”). In addition, the first names of said persons are given second priority after said last names but must be applied with said last names in said named files. There are at least two front-to-back orders of showing the first and last names of a person in a label. The middle names may be employed. Scrolling, toggling features or any combination thereof of the above information is employed.

Moreover, the present invention is a system comprises identification information of persons such as, but not limited, individual social security numbers and dates of birth of said persons for cross-checking or matching each named file to matching social security number and/or date of birth of a person whose information is in said named file. For example, highlighting a named file in said system or hierarchy of named files causes an appearance of corresponding social security number, date of birth or any combination thereof of said person of said named file on a site or sites on said display screen.

Moreover, in addition to the above, the present invention's identification information of persons will include also facial images of individuals such as, but not limited, individual photographs or pictures of said persons for cross-checking or matching each named file, social security number, date of birth or any combination thereof of a person whose information is in said named file. For example, highlighting a named file in said system or hierarchy of named files causes an appearance a corresponding image, images, photograph or photographs of a patient whose information is in said highlighted named file on a site or sites of said display screen. This application of named file and image is in addition to the above applications of social security number, date of birth or any combination thereof of said person of said named file on said display screen.

Although the preferred embodiments has been described, it will be appreciated by those skilled in the art that auditory presentation can be incorporated into the present invention within the spirit of the invention and the scope of claims.

Although the preferred embodiments of this present invention have been described for humans, it will be appreciated by those skilled in the arts that the invention is applicable to animals and objects without departing from the spirit of the invention and the scope of the claims.

Although the preferred embodiments of this invention have been described, it will be appreciated by those skilled in the art that adaptations and variations may be made without departing from the spirit of the invention and the scope of the claims.

1. A system of file names comprises identification information of persons for labeling files in a digital voice recorder wherein said file names appear on a display screen of said digital voice recorder and wherein each file name effects a dictation of a person's information into a desired named file.

2. The system according to claim 1 wherein said identification information of persons comprise individual distinct names of individual persons.

3. A system of file labels comprises identification information of persons for labeling files and for cross-checking or verifying a match of a person and a corresponding named file in a digital voice recorder wherein said file names appear on a display screen of said digital voice recorder and wherein an identification information of said information effects a dictation of a person's information into a desired named file.

4. The system according to claim 3 wherein said identification information of persons for labeling files comprise distinct names of persons.

5. The system according to claim 1 wherein said identification information of persons for identifying files include numeric identification information of persons.

6. The numeric identification information according to claim 5 include social security numbers of persons.

7. The numeric identification information according to claim 5 include dates of birth of persons.

8. The system according to claim 3 wherein said identification information include alphanumeric identification information of persons.

9. The individual alphanumeric identification information according to claim 8 include dates of birth of persons.

10. The system according to claim 3 wherein said identification information of persons for labeling files comprise images of persons.

11. A hierarchy of file names comprises distinct names of patients for naming or labeling individual files each of which comprises health-care information on each of said patients in a digital voice recorder wherein said hierarchy of file names appears on a display screen of said digital voice recorder and wherein a file name of a patient in said hierarchy effects a physician's dictation of said patient's information into said patient's named file.
